(19) United States
(12) Patent Application Publication
(10) Pub. No.: US 2002/0062223 A1
(43) Pub. Date: May 23, 2002

(54) System and method for adding network traffic data to a database of network traffic data

(75) Inventor: Martin Waugh, Portland, OR (US)

Correspondence Address: MARGER JOHNSON & McCOLLOM, P.C., 1030 S.W. Morrison Street, Portland, OR, 97205, US

(73) Assignee: NETIQ CORPORATION, Portland, OR

(21) Appl. No.: 10/010,627

(22) Filed: Nov. 8, 2001

Related U.S. Application Data
(60) Provisional application No. 60/252,522, filed on Nov. 21, 2000.

(51) Int. Cl. G06F 17/60

(52) U.S. Cl. 705/1

(57) ABSTRACT

Hit records are retrieved from a log file of network traffic data. Visit information is recognized from the hit records, and stored in a database. The visit information can then be analyzed to determine the success of a business's web site.

### RELATED APPLICATION DATA

This application claims priority from U.S. Provisional Patent Application Serial No. 60/252,522, titled “SYSTEM AND METHOD FOR ADDING NETWORK TRAFFIC DATA TO A DATABASE OF NETWORK TRAFFIC DATA,” filed Nov. 21, 2000. This application incorporates by reference U.S. patent application Ser. No. 09/240,208, titled “METHOD AND APPARATUS FOR EVALUATING VISITORS TO A WEB SERVER,” filed Jan. 29, 1999.

### FIELD OF THE INVENTION

This invention pertains to traffic monitoring and more particularly to storing traffic data in a database.

### BACKGROUND OF THE INVENTION

The rise of electronic commerce (or e-commerce) has focused attention on the need to find out information about visitors. The simplest way to track visitor information is via hits. Each time some information is displayed to a visitor on his computer, a hit happens. The hit might be for a large block of information (for example, an entire web page), or might be for a small piece of information (for example, a picture displayed to the visitor). Typically, for each web page loaded on a visitor's computer, many hits occur.

FIG. 1 shows a prior art database structure for tracking hit records. In FIG. 1, hit table 105 stores various pieces of information found in hit records, such as an ID for the hit record, the time and date of the hit, what the referring web site was (if the visitor was referred to the web site), the uniform resource locator (URL) visited by the visitor, and an ID for a cookie placed on the visitor's computer. Links also exist to other tables, such as cookie table 145 and referrer table 155, which can store additional information about the visitor's visit.

Because each web page loaded can generate multiple hits, counting hits does not provide a good measure of a web site's business. A single visitor can quickly generate hundreds of hits. Furthermore, the visitor does not have to actually make a purchase to generate hits. The hits are generated whether or not the visitor buys anything.

Generally the hit records themselves are stored in a database. When a business wants to find out about its e-commerce success, the information is distilled from the hit records. When more hit records are loaded from a log file, the analysis starts over. Since hit records include much information that is valueless (such as when images of products are loaded), they occupy a lot of space. What is needed is a way to store meaningful information derived from the hit records without storing the hit records themselves, thereby saving storage space and analysis time.

The present invention addresses these and other problems associated with the prior art.

### SUMMARY OF THE INVENTION

The invention is a method for storing network traffic data. Hit records are retrieved from a log file. From the hit records, visit and visitor information is generated and stored in a database.

The invention further includes an apparatus structured to store the visit and visitor information. A computer stores a database, which contains visit information. The visit and visitor information is derived from a log file accessible from the computer, the log file containing hit records.

The foregoing and other features, objects, and advantages of the invention will become more readily apparent from the following detailed description, which proceeds with reference to the accompanying drawings.

### BRIEF DESCRIPTION OF THE DRAWINGS

FIG. 1 shows a prior art database structure for tracking hit records.

FIG. 2 shows a computer system designed to distill visit information from hit records for a web site according to the preferred embodiment of the invention.

FIG. 3 shows the web pages of FIG. 2 in more detail, as accessed by a visitor.

FIG. 4 demonstrates the two preferred techniques used to identify a particular visitor in the embodiment of the invention shown in FIG. 2.

FIGS. 5-11 show details of the database of FIG. 2 for distilling and storing visit information according to the preferred embodiment of the invention.

FIG. 12 shows how visitor attributes are linked to visitors in the database of FIG. 2.

FIGS. 13A-13B show a flowchart of the method to analyze hit records on the computer system of FIG. 2 according to the preferred embodiment of the invention.

FIG. 14 shows a flowchart of the method to determine visit information from the hit records on the computer system of FIG. 2 according to the preferred embodiment of the invention.

FIG. 15 shows a flowchart of a method to eliminate double-counting of hit records in determining the visit information on the computer system of FIG. 2 according to one embodiment of the invention.

FIG. 16 shows a flowchart of a method to eliminate double-counting of hit records in determining the visit information on the computer system of FIG. 2 according to another embodiment of the invention.

FIG. 17 shows a flowchart of the method to determine visit information to visitors in the database of FIG. 2 according to the preferred embodiment of the invention.

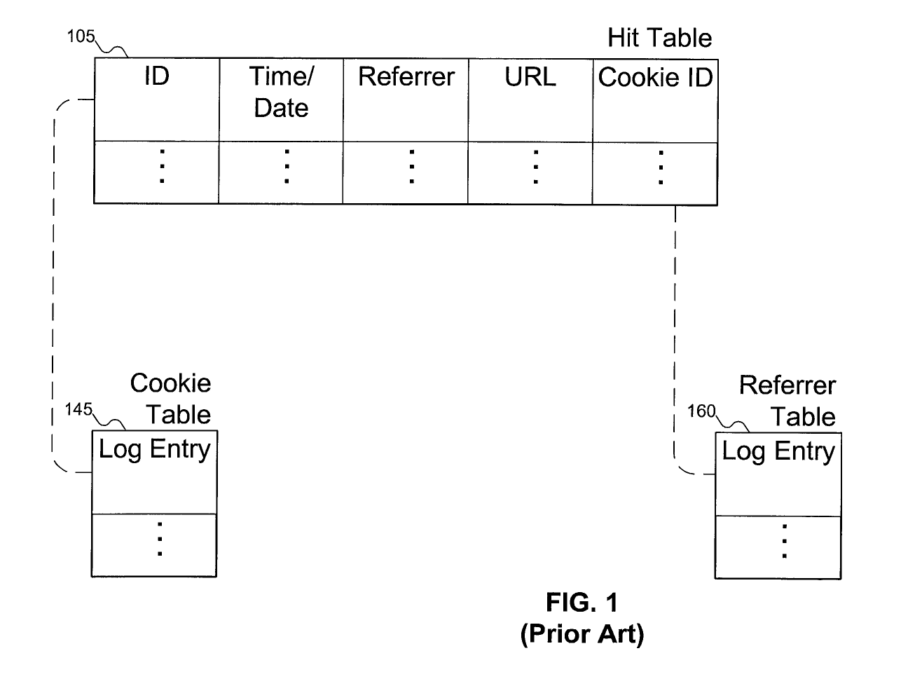

### DETAILED DESCRIPTION OF THE PREFERRED EMBODIMENT

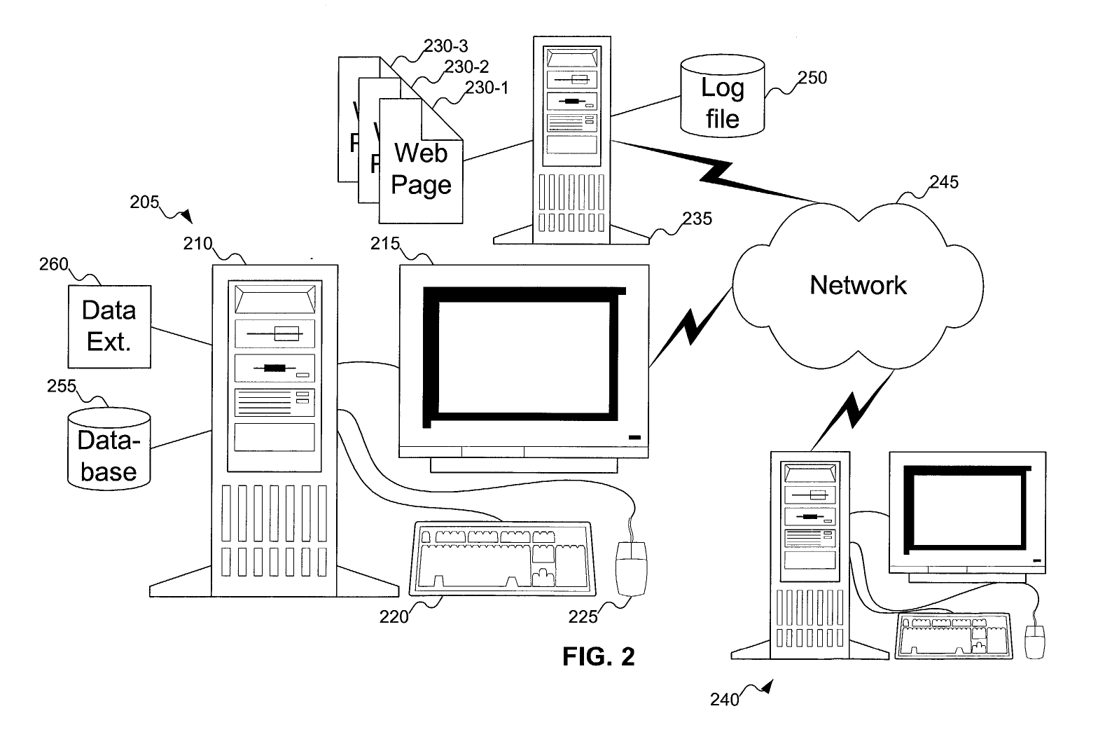

FIG. 2 shows a computer system designed to distill visit information from hit records for a web site according to the preferred embodiment of the invention. For purposes of the discussion below, a computer system includes one or more computers interconnected by networks. Thus, for example, the computer system shown in FIG. 2 includes three computers: computer 205, computer 240, and server 235.

Computer 205 conventionally includes a box 210, a monitor 215, a keyboard 220, and a mouse 225. Optional equipment not shown in FIG. 2 can include a printer and other input/output devices. Also not shown in FIG. 2 are the conventional internal components of computer 205: e.g., a central processing unit, memory, file system, etc.

Web pages 230-1, 230-2, and 230-3 are part of a web site maintained by a company. Web pages 230-1, 230-2, and 230-3 are shown in FIG. 2 as being stored on server 235. However, a person skilled in the art will recognize that web pages 230-1, 230-2, and 230-3 can be stored on computer 205. Additionally, a person skilled in the art will recognize that there can be fewer or more web pages than the three web pages shown in FIG. 2.

A visitor, using computer 240, can access web pages 230-1, 230-2, and 230-3 via network 245. Network 245 can be an internetwork, a direct connection to server 235, or any other way in which computer 240 can access web pages 230-1, 230-2, and 230-3. As the visitor accesses web pages 230-1, 230-2, and 230-3, log file 250 stores the hit records generated by the accesses. As discussed above, in general a hit record is generated for each individual element used to display a web page. Thus, log file 250 stores a hit record for each image, streaming content, and block of text displayed to the visitor.

Every so often, computer 205 accesses log file 250 and reads the hit records stored therein. Although computer 205 is shown accessing log file 250 via network 245, a person skilled in the art will recognize that other techniques can be used to access log file 250, such as a direct connection to server 235, storing log file 250 on computer 205 (i.e., giving computer 205 the functionality of server 235), or manually transporting log file 250 to computer 205. Information is then distilled from the hit records and stored in database 255 for use as desired. Data extractor 260 is used to extract information from the hit records.

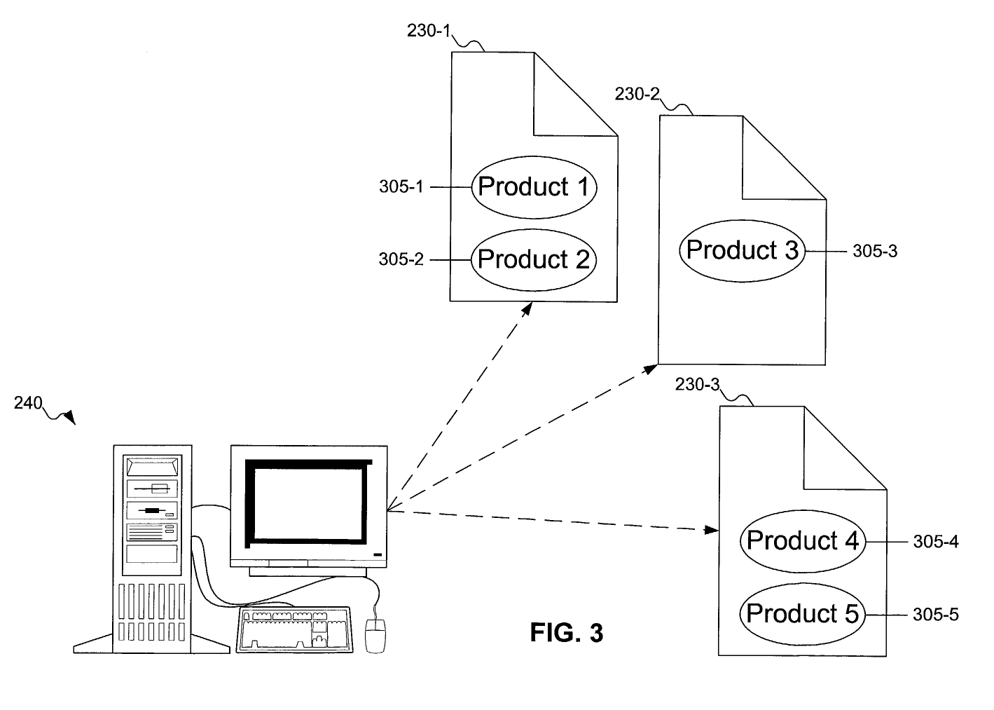

FIG. 3 shows the web pages of FIG. 2 in more detail, as accessed by a visitor. In FIG. 2, the visitor using computer 240 views (presumably at different times) web pages 230-1, 230-2, and 230-3. On web pages 230-1, 230-2, and 230-3 is information about a variety of products 305-1, 305-2, 305-3, 305-4, and 305-5. As each web page is loaded for viewing by the visitor, hit records are stored in log file 250. The visitor can access more information about these products. For example, products 305-1, 305-2, 305-3, 305-4, and 305-5 might include hyperlinks that the visitor can select for more information.

As discussed above, hit records are an inconvenient form for managing data about a web site. The preferred embodiment of the invention processes the hit records into a more manageable data form. Instead of storing each hit record separately, the invention groups the hit records into visits, and then stores information about each visit. Consider, for example, a clothing store web site, where the web site includes a page that shows 10 different styles of pants. The business would not interested in knowing that there are hit records for pictures of each style of pants, since these hit records would be generated for each visitor to that page. Instead, the business might be interested in knowing that a visitor looked into purchasing a particular style of pants. Thus, significant numbers of hit records can be reduced down to a single data point. (This example tends to oversimplify the situation, in that it assumes a great many hit records can be consolidated to a single data point. It is more likely that the hit records for the multiple web pages visited by the visitor can be distilled down to a number of data points. But generally no predictable formula can establish a relationship between the number of web pages visited, the number of hit records generated, and the number of data points of interest.)

Generating visit information from hit records begins by assigning each hit record to a visit. A visit is defined as all activities by a single visitor at the business's web site while the visitor is “in” the store. But unlike the real world analog of visiting a store, it is not easy to tell when a visitor has left. For this reason, a visit is deemed to end when the visitor has taken no action at the business's web site for a given length of time (in the preferred embodiment, this interval is 30 minutes, but a person skilled in the art will recognize that other intervals can be used and that this interval can be customized). Thus, a single visitor can have multiple visits to a business's web site over time, and can also have one very long visit to the business's web site.

Related to the definition of a visit is the question of which hit records belong to which visitors. Several different techniques can be used to identify a particular visitor. The two preferred techniques used to identify a particular visitor are Internet Protocol (IP) addresses and cookies. The principle behind using IP addresses is that a visitor's IP address is fixed for the duration of the visitor's connection to the Internet. The principle behind using cookies is that the business can drop a cookie onto the visitor's computer, which can be sent back to the business when the visitor visits the business's web site.

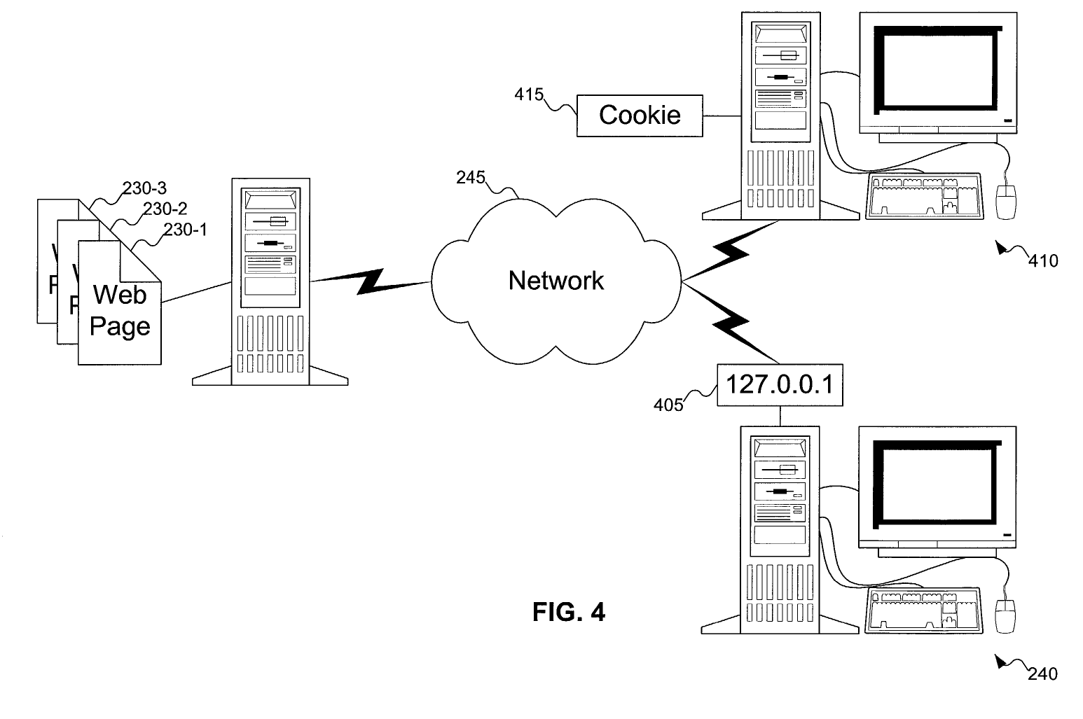

FIG. 4 demonstrates the two preferred techniques used to identify a particular visitor. In FIG. 4, the visitor using computer 240 is currently assigned IP address 127.0.0.1 (as shown by IP address 405). As long as the visitor continues to shop and does not release IP address 405, hit records the visitor generates will be added to his current visit. In contrast, the visitor using computer 410 has accepted cookie 415 on his system. As long as the visitor continues to shop and does not delete cookie 415 from his computer, hit records the visitor generates will be added to his current visit.

Although IP addresses and cookies serve well to identify visitors, they are not foolproof. If a visitor inadvertently loses his Internet connection in such a way that when he reconnects, he generally will have a different IP address, he will look like a different visitor to the business. This happens most frequently with connections that are not permanent (e.g., dial-up connections).

There is also the possibility that another user can be assigned the IP address of the disconnected visitor, and that this user can also visit the business's web site. If that later visitor connects to the business's web site soon enough after the earlier visitor was disconnected, the later visitor will look like the earlier visitor. In that case, hit records that should be assigned to different visits will be incorrectly assigned to a single visit.

With cookies, if the visitor deletes the cookie from his computer, the visitor identification will be lost, and a new cookie will have to be issued. When this new cookie is transmitted to the business's web site, it will look like a new visit has begun. Hit records that should be assigned to a single visit might then be split incorrectly among two or more visits.

The visitor can also refuse to accept cookies. In that case, the visitor's IP address can be used to identify the visit.

The above types of misidentifications, which result in either hit records for a single visit being assigned to multiple visits or hit records for different visits being combined, are all possible. But the likelihood of such misidentifications is low.

Once a visit is identified as having begun, each hit record that is part of the visit can be assigned to the visit. As described above, the visit is considered complete when the visitor has engaged in no activity at the business's web site for a predefined period of time. As each hit record is examined, the time delta between that hit record and the previous hit record associated with the visitor (either by IP address or cookie) is determined. If the time delta is less than the predefined period of time (in the preferred embodiment, 30 minutes), then the hit record is assigned to the same visit as the previous hit record.

Once all the hit records are assigned to a visit, information can then be gleaned from the visit. For example, the visit can be analyzed to determine what content groups the visitor looked at, what advertising campaigns brought the visitor to the business, etc. One particular type of visit information is information about the visitor: for example, gender, age group, ethnicity, etc. Preferably the visitor can provide information about himself, for example, via a web-based form.

Content groups (mentioned above) define particular types of content offered by the business that can be viewed by the visitor. For example, a clothing store can set up a content group called “pants” that refers to content describing pants offered for sale by the business. Content groups are preferably defined using a uniform resource locator (URL) with wildcards (e.g., “*/pants”). Then, whenever a hit record includes a URL that matches the pants content group, the visit information can indicate that the visitor viewed the pants content group.

Content groups can extend beyond products or services offered by the business. For example, a content group can be established for an advertising campaign. Consider a business that sends an e-mail on a particular day to previous visitors. The e-mail includes a link to a web page within the business's web site. When the visitor selects the link, a hit record is generated for the web page (which can automatically forward the visitor to the business's home page). Based on the hit record, the business can know that the visitor “viewed” the e-mail advertisement content group.

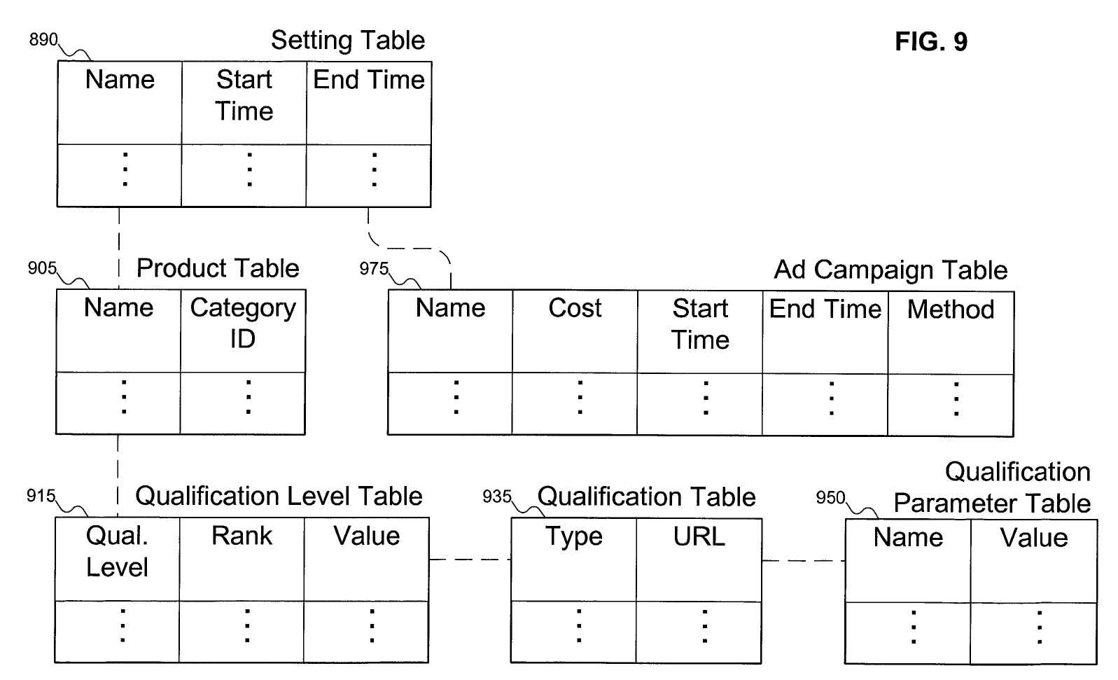

Content groups are stored as settings within the database. Settings are discussed further with reference to FIGS. 9-11, below.

Consider again the clothing store with a web site, and assume that the clothing store is running an advertising campaign. A visitor sees one of the ads and visits the web site. The visitor looks at a variety of different products, including shoes, pants, and shirts, before deciding to order a pair of pants. The visitor then leaves the web site, and does not return for an amount of time sufficient to demarcate the end of the visit (as discussed above, by default this span is 30 minutes).

First of all, an entry is created for the visit. This entry includes a unique ID for the visit, a unique ID that identifies the visitor, and specifies the time of the visit, among other things. If the visitor happens to return at another time for a second visit, a new ID will be assigned to the second visit: in other words, different visits by the same visitor are treated separately. In general, visitor IDs are also unique to each visit, since the business cannot be completely certain that the visitor during a later visit is the same as a visitor from an earlier visit (e.g., the IP address used to identify the visitor might have been dynamically assigned to two different users). But the visitor can have the same visitor ID, assuming the visitor can be positively identified.

Using the ID for the visit, visit attributes can be determined and stored. As discussed above, visit attributes include such data as products investigated and their groups, advertising campaigns that trigger visits, and so forth. For the visitor above, a visit attribute can be created identifying the ad campaign that brought the visitor to the business, the purchase of pants, and the content group (men's clothes, for example). Other information can also be attached to the attribute: for example, the time at which the hit occurred, from which the attribute was derived.

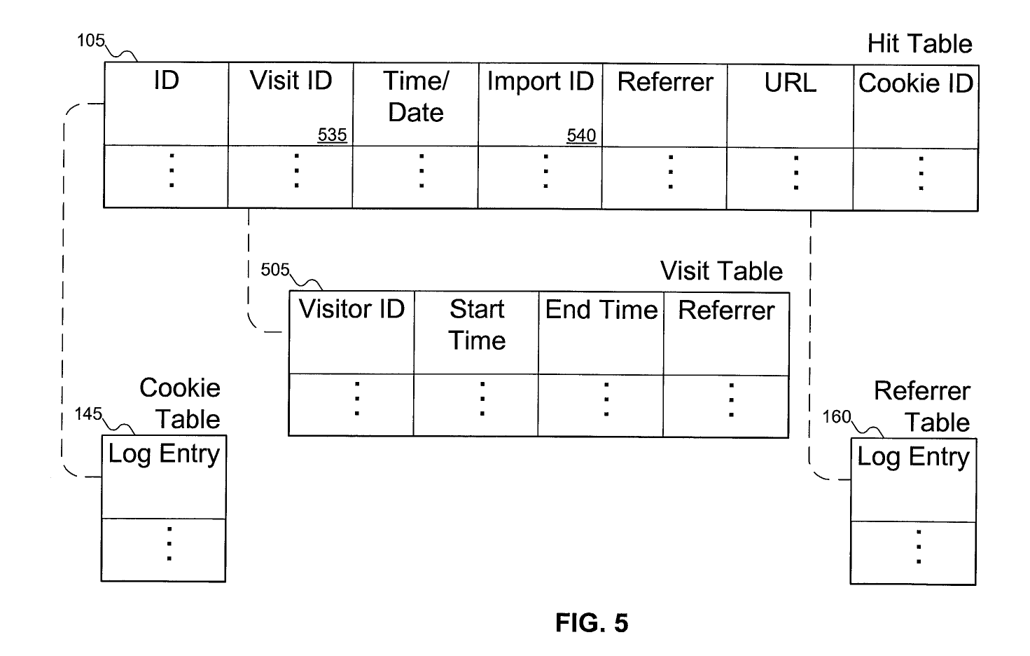

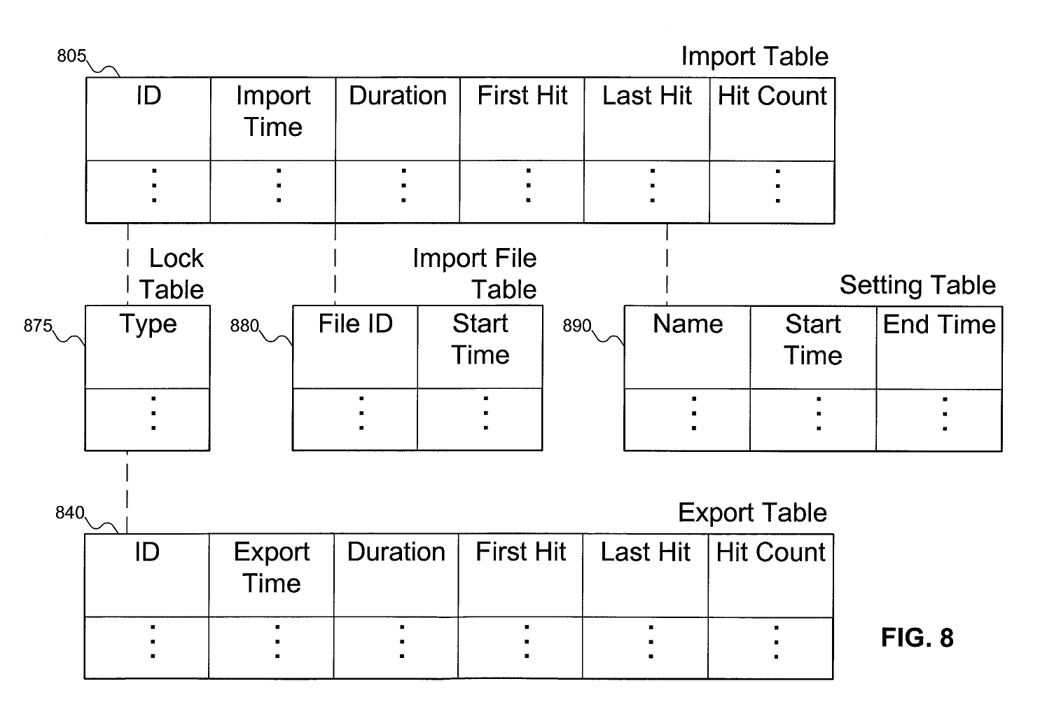

Now that the use of the database has been described, the structure of the database can be explained. FIGS. 5-11 show details of the database of FIG. 2 for distilling and storing visit information according to the preferred embodiment of the invention. In FIG. 5, hit table 105 has been modified to include two new fields: visit ID 535 and import ID 540. Visit ID 535 is used to identify the visit to which the hit record is assigned. Import ID 540 is used to track the import operation that read the hit record into the database (see below with reference to FIG. 8 for more information).

In addition, visit table 505 is added. Visit table 505 tracks information about a single visit, such as an ID for the visit, the start and end times of the visit, and the uniform resource locator (URL) that referred the visitor to the web site.

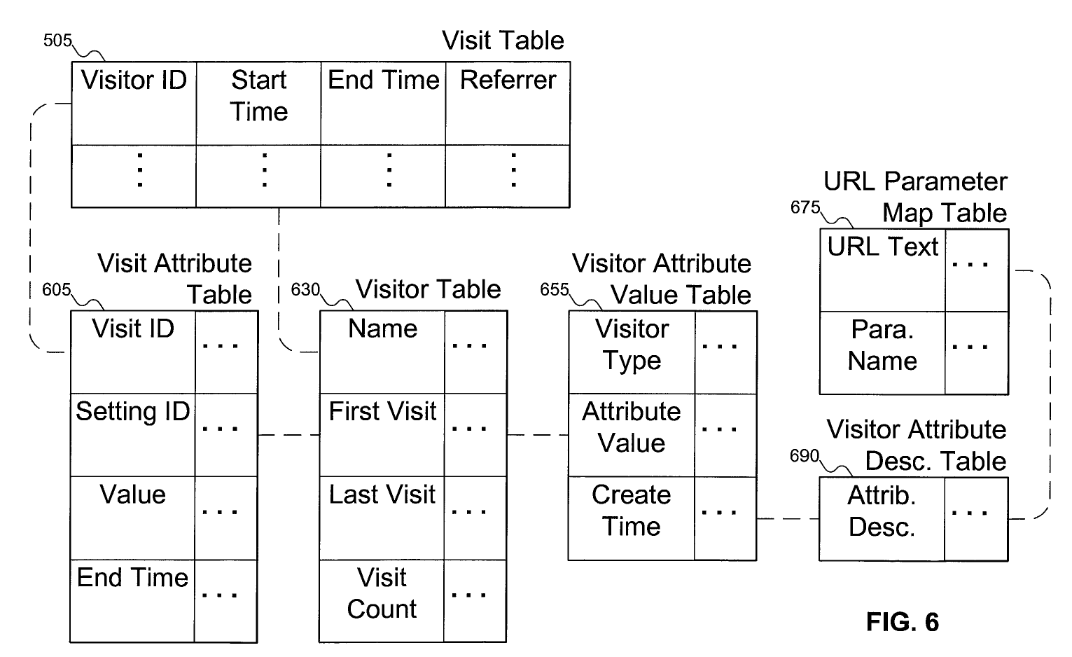

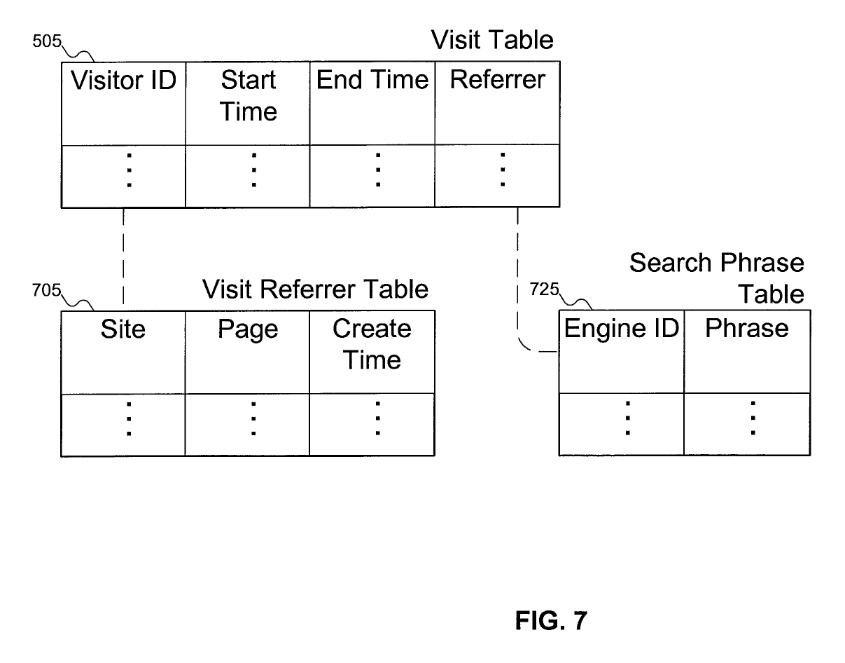

FIGS. 6 and 7 show tables that store information about a particular visit. Referring to FIG. 6, visit attribute table 605 stores attributes about a visit. For example, some visit attributes that can be determined are the products and classes of products about which the visitor inquired, the advertisements seen or clicked, and the advertising campaign that triggered the visitor to visit the site.

Visitor table 630 stores information about individual visitors. For example, visitor table 630 can store the name of the visitor, the date/time of his first or last visit, and the number of times the visitor has visited the web site. Visitor table 630 includes predefined fields for the most frequently tracked visitor characteristics.

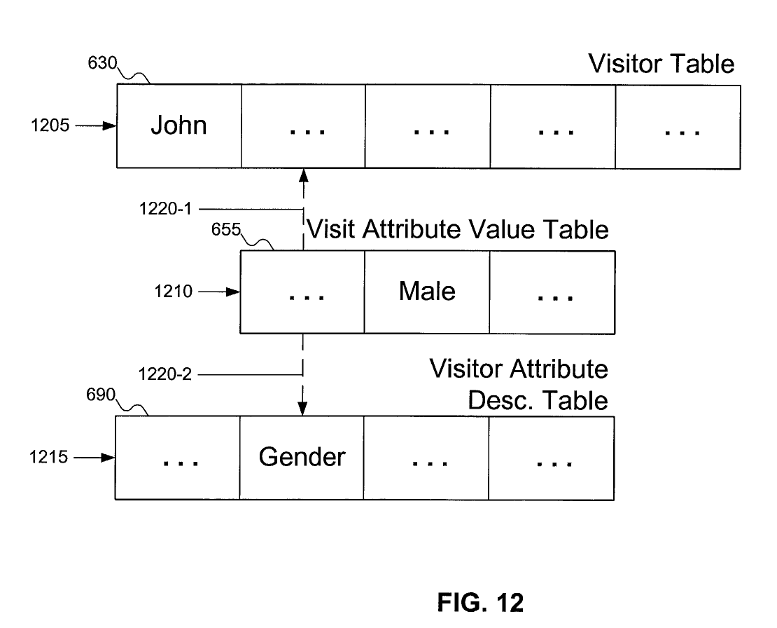

Although the visit attributes that can be captured are predetermined in the preferred embodiment of the invention, the visitor attributes stored in visitor attribute table 630 are preferably customizable. The customization is achieved through visitor attribute description table 690, visitor attribute value table 655, and URL parameter map table 675. Visitor attribute description table 690 stores identifiers for attributes to be individually tracked. Visitor attribute value table 655 stores the value for the customized attribute for individual visitors. URL parameter map table 675 stores where the attribute value can be located. For example, gender is not automatically tracked in the preferred embodiment of the invention. If a business wants to track the gender of its visitors, it adds an entry to visitor attribute description table 690 naming the attribute (“gender”) and specifies where the attribute value can be determined in URL parameter map table 675 (e.g., the web page and parameter name from which the gender can be determined). Then, when the appropriate web page is loaded, the parameter is accessed, and the value is stored in visitor attribute value table 655, which is cross-linked to the entry in visitor attribute description table 690 and the entry in visitor table 630. This is discussed further with respect to FIG. 12, below.

Referring to FIG. 7, visit referrer table 705 stores information about who referred a visitor visiting the web site. The referrer is the site from which the visitor came to the business's web site. The visitor can be referred by any link on the referrer (not just an ad).

One particular type of referrer is a search engine. When the referring URL is analyzed and determined to be a search engine, search phrase table 725 stores the search phrase the visitor used that brought the visitor to the web site. The search phrase can usually be determined from the URL of the referring search engine. A person skilled in the art will recognize that the tables shown in FIGS. 6-7 are merely representative, and that other visit specific information can be tracked and stored using database 255.

FIG. 8 shows the tables used to control the import and export operations on database 255. Import table 805 and export table 840 track information such as the time of the import/export operation, the range of hit records covered by the import/export operation, and the number of hit records imported/exported. Both import table 805 and export table 840 can access lock table 875. Lock table 875 is a semaphore and is used to prevent simultaneous import and export of hit records in the same time range (sometimes called a time slice or time interval). Import file table 880 specifies the file from which the hit records are imported. A similar table can be used to store the name of the file to which hit records are exported.

Lock table 875 is used to avoid conflicts. In general, imports and exports of data from different time ranges in the database can be performed at the same time. But data from the same time range should not be imported and exported simultaneously, as this could result in incorrect data. Lock table 875 can be used to prevent the simultaneous import and export of data in the same time range. If either an import or an export operation is occurring and another operation is attempted on the same time range, lock table 875 can block the second operation from beginning until the first operation completes.

Setting table 890 is accessed to take snapshots of the settings used in analyzing the hit records. Setting table 890 acts as an identification point for the various settings. From the ID associated with setting table 890, a particular setting can be located and its value used. When settings change, the analysis of the hit records changes accordingly. Without setting table 890, if settings are changed, it is very difficult to determine the reason behind the change in analysis. For example, as discussed above, the default interval between hit records associated with a visitor to determine the end of a visit is 30 minutes. If this interval is changed to 15 minutes, the number of visits will typically increase. If the change in settings is not recorded, a business might not be able to figure out why the traffic at his web site has “increased,” or why there was no increase in sales.

One advantage in the use of import table 805 and export table 840 lies in the elimination of double-counted records. For example, it can happen that a hit record retrieved from log file 250 is assigned to a visit begun before the import operation (i.e., the hit record is within the time delta of a previous hit record imported in an earlier import operation). When a hit record retrieved in an import operation is assigned to a visit begun during an earlier import operation, the visit is called an open visit. If new visit information were generated based on the visit, the hit records imported in the earlier import operation would be double-counted (once after the earlier import, and once again after the current import). But if all the records in the database associated with the ID for the open visit are identified and purged, the visit information can then be recreated, providing accurate information without double-counting records.

A second advantage to the import/export history is the taking of a snapshot of the settings information from settings table 890. If settings are changed between import operations, the interpretation of the data will change. For example, consider a change where the timeout between hits (used to determine when a visit has ended) is changed from 30 minutes to 15 minutes. As a result, many more visits will be identified. Examining the snapshot of the settings allows the business to understand why the visit data appears substantially changed for no apparent reason.

A second example of the use of the snapshot can be found in hit records in the log file associated with images. For many web sites, a significant percentage of the hits recorded in the log file are requests to retrieve images (GIFs or JPGs). In general, the business is not interested in knowing that these images were viewed by a visitor (although there are situations where this information can be important). When the log file is read and the hit tables loaded, the database can be instructed to ignore any entries in the log file relating to images. This filtering is a setting stored in the snapshot in the import/export history, as without knowing about this filtering, data interpretation can change.

The hit tables can be set up to purge records that are sufficiently aged (for example, hit records more than six months old). The IDs in import table 805 and export table 840 can be used to determine which records can be purged. Note that this does not mean that data is lost, since the hit records can always be re-retrieved from the log file.

Earlier, the concept of an open visit was introduced. The most intuitive form of an open visit is where hit records are imported, but the visit was not closed before the last hit record was imported (i.e., at the time the hit records were imported to the database, the visitor was not finished visiting the business's web site). However, there are other forms of open visits.

First, visits can open at either end. That is, the visit can also be considered “open” at the beginning (meaning that data from before the hit records were imported is missing). This situation arises most frequently when hit records are imported out of order. For example, hit records for Monday are imported into the database, followed by hit records for Wednesday. Later, hit records for Tuesday are imported. After the hit records for Wednesday are imported, visit information is extracted from these records. This visit information can be inaccurate because a visit was started on Monday and on Tuesday, or was started on Tuesday and finished on Wednesday. In both situations, visit information is inaccurate. Once the hit records for Tuesday are imported, the inaccurate visits can be updated by splicing in the data from Tuesday.

A third way visits can be inaccurate is where multiple servers log hit records. Often, a business runs multiple servers for its web site. As network traffic increases to the business's web site, the servers dynamically allocate the load between themselves. This is accomplished transparently to the visitor: he has no knowledge of (and does not care about) which server is currently processing his requests.

If hit records are imported from some but not all of the business's servers, then there can be gaps in the visit information. For example, consider again a visitor to a clothing store's web site. One server for the clothing store ends up processing all of the visitor's requests for information, but another server ends up processing the actual purchases. If hit records are imported from only the first server, then the visit information will end up missing the purchases. Thus, the visitor's visit information is inaccurate. When the second server's hit records are imported, the visit information is regenerated to extract accurate visit information.

Note that all of the ways visit information can be inaccurate can be resolved using the same technique. The database is locked, and the new hit records are read in. A time interval is determined by widening the times for the imported hit records by the time limit for closing visits. Since the default time limit for closing visits is 30 minutes, the time interval includes the time from 30 minutes before the first imported hit record to 30 minutes after the last imported hit record. All visits with data in the time interval can then be regenerated to eliminate any inaccurate visit information.

FIGS. 9-11 show tables that store information about settings that control the recognition of events of interest in database 255. Referring to FIG. 9, product table 905 defines how products displayed on a business's web site can be recognized the from the hit records and stored in database 255. Qualification level table 915 defines the different qualification levels a visitor can attain by interacting with individual products. For example, the visitor can be assigned one qualification level for viewing a brief description of the product, a higher qualification level for viewing a full description of the product, and a third qualification level for ordering the product from the web site. Qualification table 935 specifies how the visitor attains the different qualification levels. Typically, qualification table 935 stores the URL the visitor must visit to reach each qualification level. Qualifying for a qualification level might also need the URL to include a qualifying parameter. Qualification parameter table 950 instructs database 255 as to how to determine the parameter from the URL stored in qualification table 935. Ad campaign table 975 stores information about how to recognize an advertising campaign that referred the user, as well as information about the advertising campaign. Typically, the advertising campaign is recognized from the web page at which the visitor entered the business's web site. Each advertising campaign can be assigned a different entry page, all of which automatically forward the visitor to a standard front page. But the different entry pages can be identified by URL, and used to identify the advertising campaign that referred the visitor.

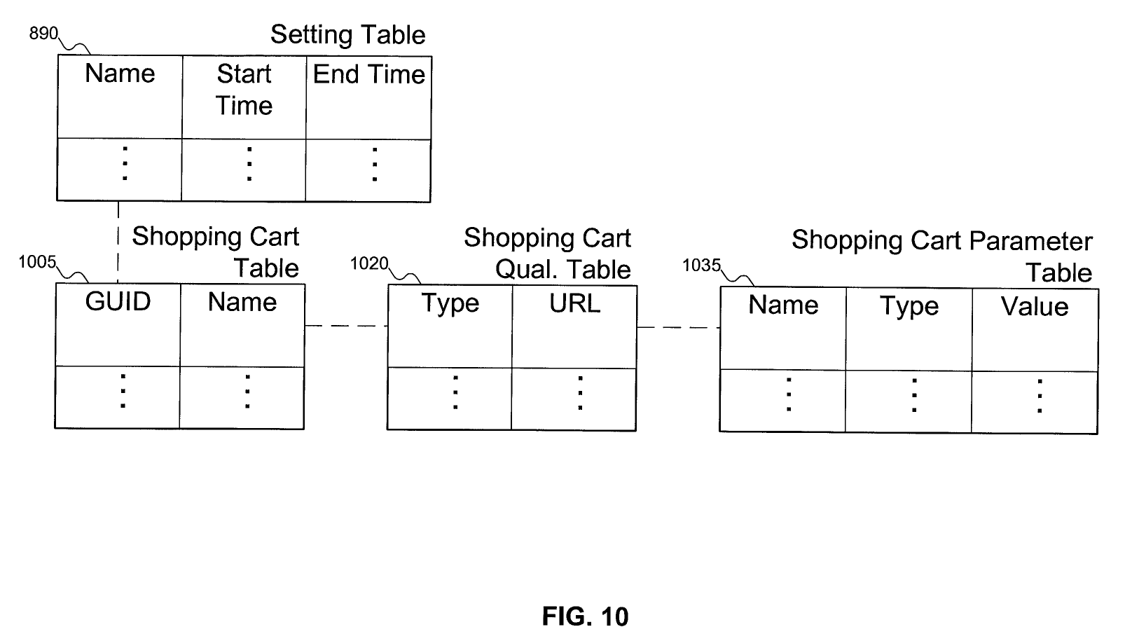

Referring to FIG. 10, shopping cart table 1005 defines what a shopping cart is. Typically, a shopping cart is defined as a particular URL, perhaps in combination with a parameter on the URL (for example, the parameter can be used to identify the particular visitor). Shopping cart qualification table 1020 stores the URL of the shopping cart. The shopping cart might also need the URL to include a qualifying parameter. Shopping cart parameter table 1035 instructs database 255 as to how to determine the parameter from the URL stored in shopping cart qualification table 1020.

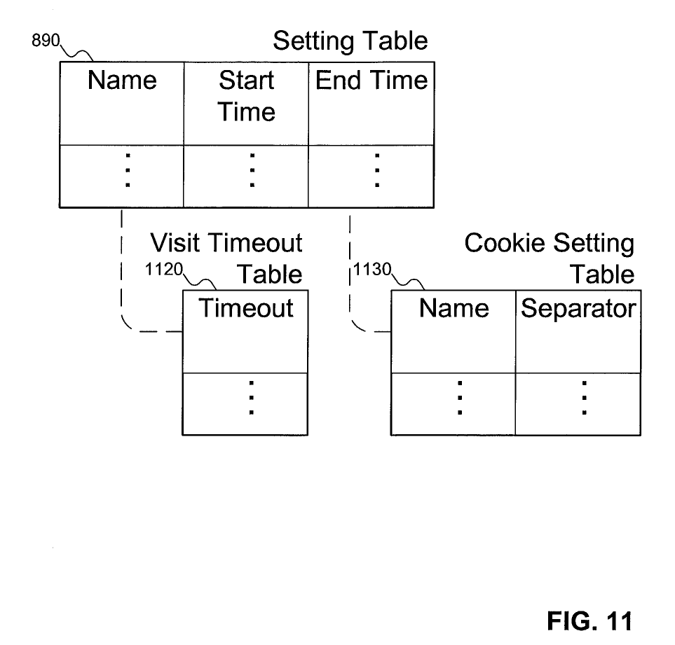

Referring to FIG. 11, Visit timeout table 1120 stores information about the interval of time that needs to pass between hit records for a new visit to begin. Cookie setting table 1130 stores information about how to parse cookies retrieved from visitor's computers, and how to separate the cookies if need be.

In general, the tables in FIGS. 9-11 linked to setting table 890 are not customizable: they are predetermined and fixed. However, in an alternative embodiment the settings can be customized by the business to track the preferred settings.

There are several ways setting table 890 can be used. One way to use setting table 890 is to create an entry for every combination of settings. For example, there can be an entry identifying a URL associated with a particular style of pants in combination with a particular advertising campaign, an entry identifying a URL associated with two particular styles of shirts, and so on. Each entry in setting table 890 can then identify a unique combination of settings, effectively turning setting table 890 into a large, sparse multi-dimensional table.

But in the preferred embodiment, each unique setting has its own ID, without being combined with any other settings. The particular combination of settings applicable to a visitor of the web site is tracked in visit attribute table 605 (see FIG. 6). This is considerably more space efficient than creating a sparse multi-dimensional table as described above. As the number of settings grows, the number of entries setting table 890 would need to uniquely identify each combination of settings, if represented as a sparse, multi-dimensional table, would grow exponentially. And many of such combinations would probably be meaningless and could never occur. By uniquely identifying each setting separately and letting visit attribute table 605 identify the combination of settings applicable to any particular visit, a great deal of space is saved.

FIG. 12 shows how visitor attributes are linked to visitors in the database of FIG. 2. In FIG. 12, the business has chosen to track the visitor attribute of gender. This attribute is normally not tracked by the database, and so the business adds the attribute in entry 1215 to visitor attribute description table 690. (The visitor also adds entries to other tables, not shown in FIG. 12, for example, specifying the URL/parameter from which the attribute can be determined.) Then, when a visitor visits the business web site (in FIG. 12, a visitor named John represented by entry 1205 of visitor table 630), the database determines the attribute value and stores it in attribute value table 655, as shown by entry 1210. As shown by links 1220-1 and 1220-2, the attribute value ties together the attribute in visitor attribute description table 690 with the visitor in visitor table 630.

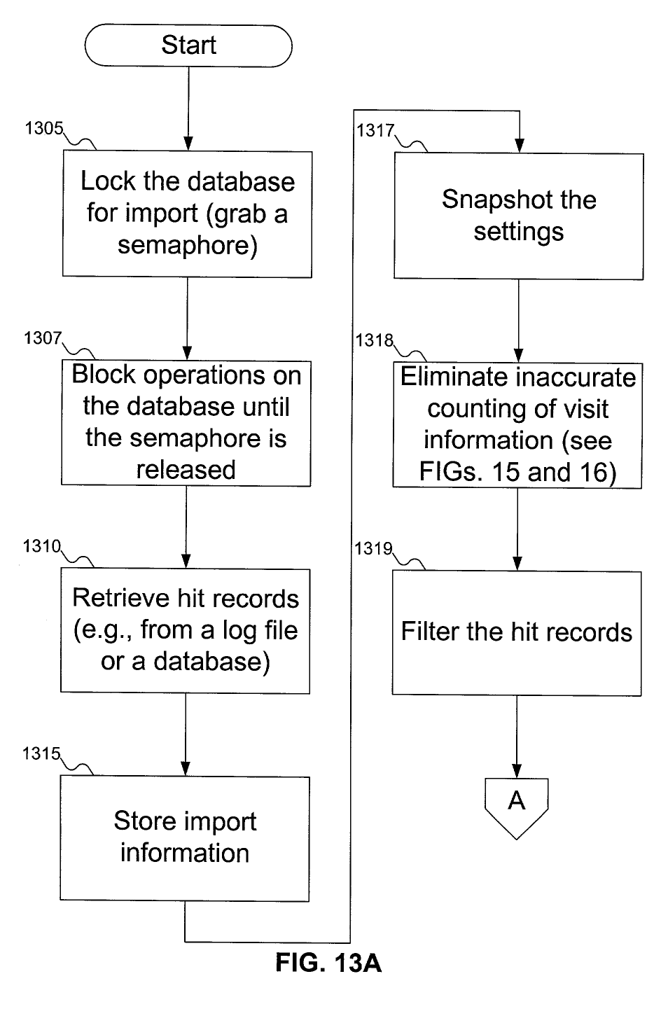

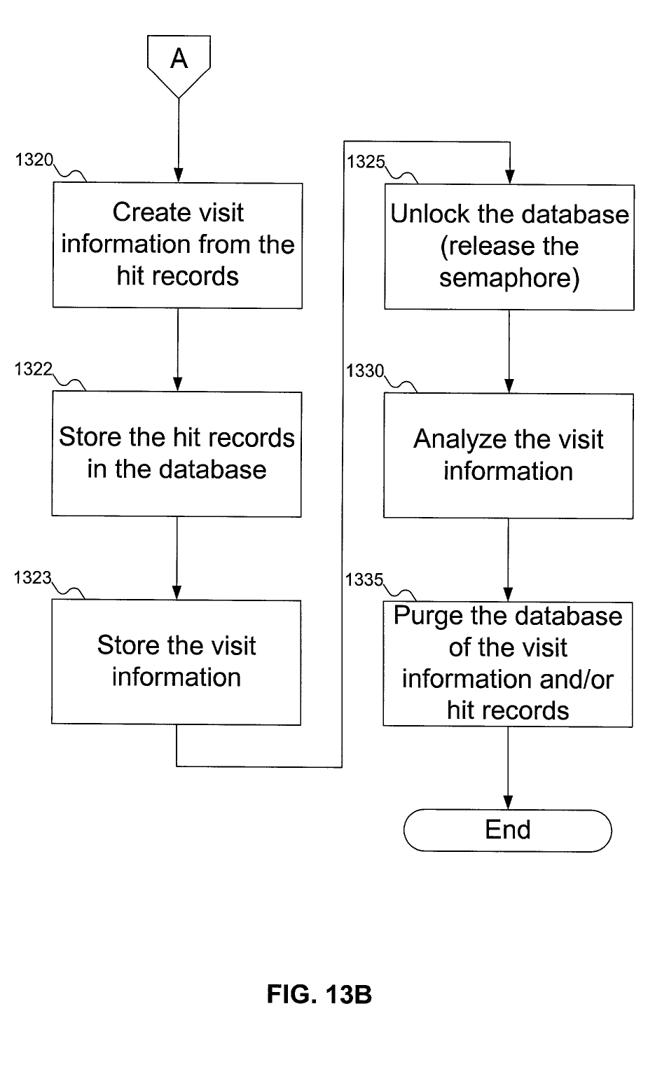

FIGS. 13A-13B show a flowchart of the method to analyze hit records on the computer system of FIG. 2 according to the preferred embodiment of the invention. In FIG. 13A, at step 1305, the database is locked for import. The database is locked so that when visit information is extracted from the hit records, the visit information is consistent with the hit records. For example, if one record reflects that a visitor has selected to purchase a product from the business at the time the records are imported, certain information gleaned about the purchase can be stored in the database. If a later hit record shows that the visitor canceled the purchase, then the purchase information does not need to be extracted. But if the later hit record is available during only part of the analysis, then the visit information may be inaccurate. Locking the database protects against such an inconsistency happening. As discussed above, only the time range of the hit records needs to be locked: hit records outside the time range can be imported or exported independently.

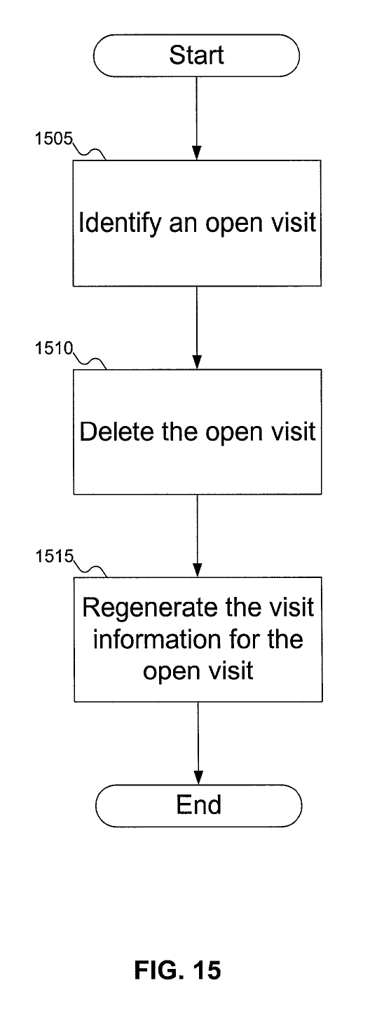

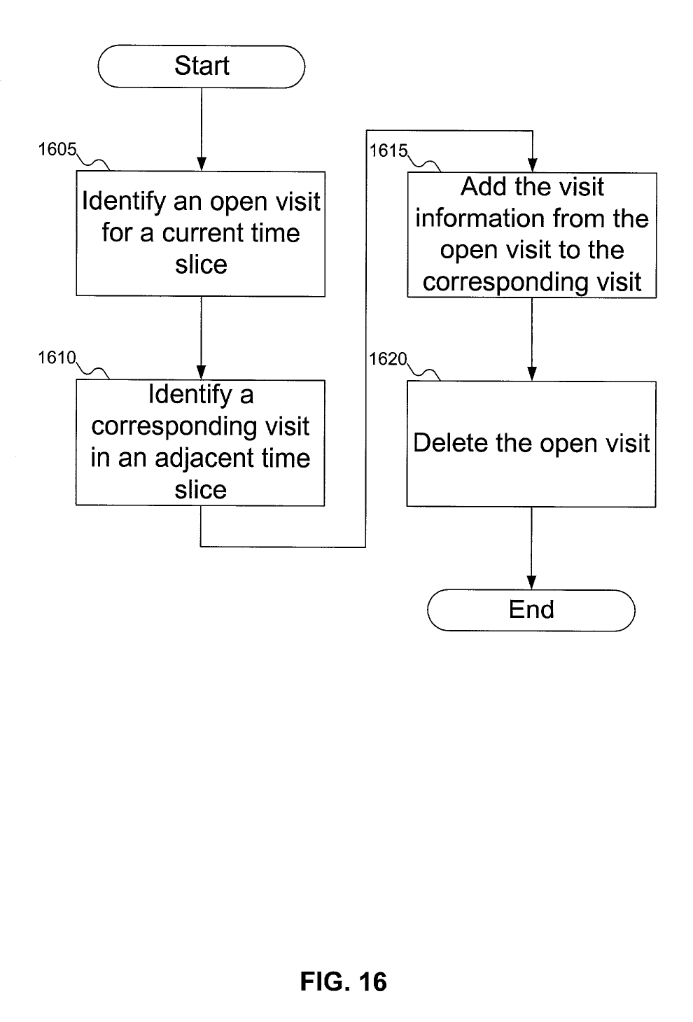

At step 1307, once the database is locked, any operations on the database involving the time range being imported are blocked. The operations are blocked until the database is unlocked in step 1325 (see FIG. 13B). Returning to FIG. 13A, at step 1310, the hit records are imported. The hit records can be imported either from the log file (if the hit records do not already exist in the database), or they can be imported from the database itself. At step 1315, import information is stored in the import tables in the database. At step 1317, a snapshot is taken of the settings in the database, as described above with respect to FIGS. 9-11. At step 1318, any inaccurate counting of visit information is eliminated. See below with reference to FIGS. 15 and 16 for further information. At step 1319, the hit records are filtered, as described above, to reduce the amount of data extraction performed. At step 1320, visit information is derived from the hit records.

At step 1322 (FIG. 13B), the hit records are stored in the database. At step 1323, the visit information extracted from the hit records is stored in the database. At step 1325, the database is unlocked, enabling import and export operations on the locked time range. At step 1330, the visit information is analyzed for data of interest to the business. Finally, at step 1335, the database can be purged of visit information or hit records. Typically, the database is purged of records that are outdated and no longer of value, but a person skilled in the art will recognize that any visit information or hit records can be purged.

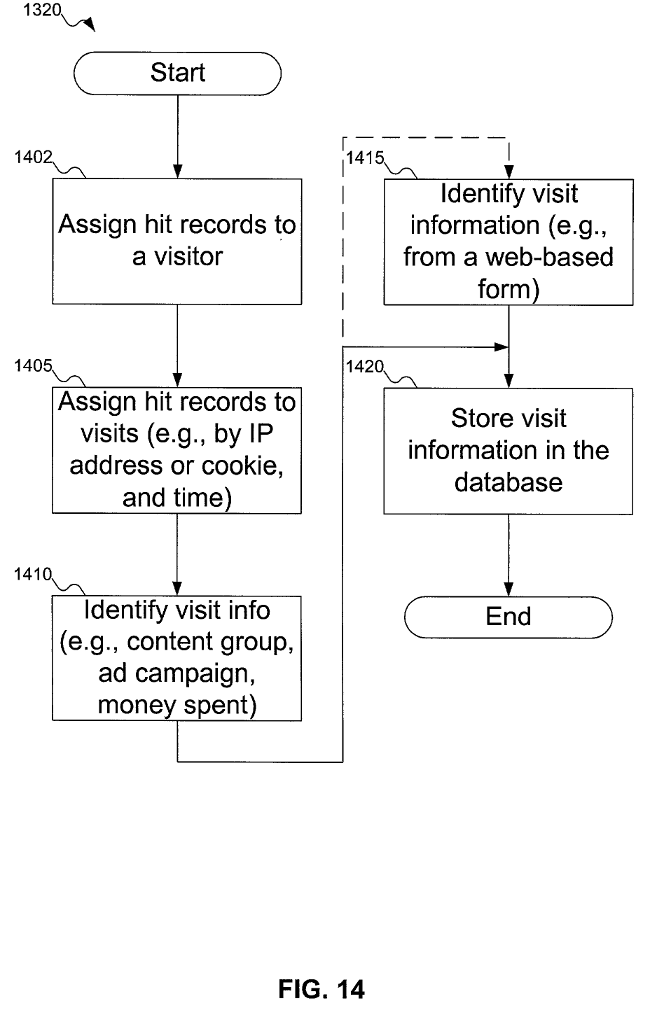

FIG. 14 shows a flowchart of the method to determine visit information from the hit records on the computer system of FIG. 2 according to the preferred embodiment of the invention. FIG. 14 shows more detail about step 1320 of FIG. 13. At step 1402, the hit records are assigned to a visitor. At step 1405, hit records are assigned to visits. As discussed above, in the preferred embodiments hit records are assigned to visits based on the visitor's IP address or cookie, and the time of the hit record. At step 1410, visit information is determined from the hit record. Such visit information can include the content page visited by the visitor, the advertising campaign that referred the visitor to the business, or the amount of money spent by the visitor on the business's web site. At step 1415, visit information is determined about the visit. Such information can include visitor attributes or characteristics (such as gender or age), and can be derived from a web-based form. Finally, at step 1420, the visit (and visitor) information is stored in the database.

FIG. 15 shows a flowchart of the method to eliminate double-counting of hit records in determining the visit information on the computer system of FIG. 2 according to the preferred embodiment of the invention. At step 1505, an open visit (a visit that began before the time of the first hit record most recently imported into the database) is determined. At step 1510, the open visit is deleted. Finally, at step 1515, the visit information for the open visit is regenerated.

FIG. 16 shows a flowchart of a method to eliminate double-counting of hit records in determining the visit information on the computer system of FIG. 2 according to another embodiment of the invention. At step 1605, an open visit for the current time slice is determined. At step 1610, a corresponding visit in an adjacent time slice is determined. At step 1615, the visit information from the open visit is added to the visit information for the corresponding visit. Finally, at step 1620, the open visit is deleted.

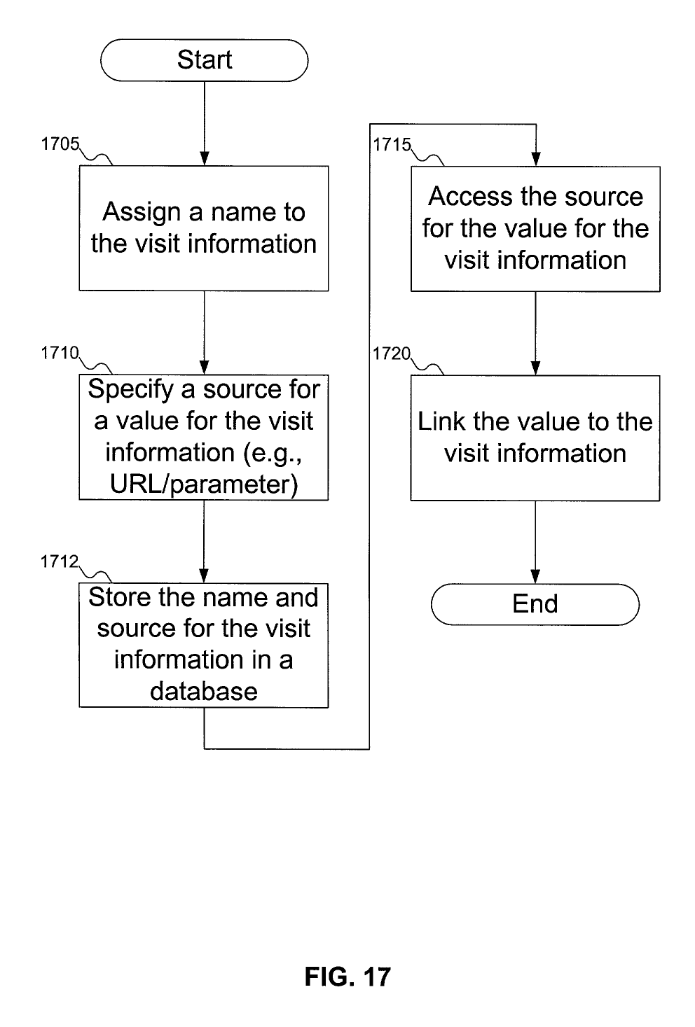

FIG. 17 shows a flowchart of the method to determine visit information in the database of FIG. 2 according to the preferred embodiment of the invention. At step 1705, the visit information is assigned a name. At step 1710, a source (such as a URL and parameter combination) for a value for the visit information is identified by the business. At step 1712, the name and source for the visit information are stored in the database. At step 1715, the source for the value is accessed. Finally, at step 1720, the value is stored in the database, linked to the visit information.

Because the process of analyzing network traffic data involves a computer, the methods described above can be implemented as instructions for a program. The program can be stored on a computer-readable medium (such as a hard disk, CD-ROM, or other media) for execution by a computer.

Having illustrated and described the principles of my invention in a preferred embodiment thereof, it should be readily apparent to those skilled in the art that the invention can be modified in arrangement and detail without departing from such principles. I claim all modifications coming within the spirit and scope of the accompanying claims.

1. A method for storing network traffic data, the method comprising:
retrieving a hit record of network traffic data;
assigning the hit record to a visitor;
recognizing visit information for the visitor based on the hit record; and
storing the visit information for the visitor in a database.

2. A method according to claim 1, wherein retrieving a hit record includes retrieving the hit record from a log file.

3. A method according to claim 1, wherein retrieving a hit record includes retrieving the hit record from the database.

4. A method according to claim 1, wherein recognizing visit information includes assigning the hit record to a visit.

5. A method according to claim 4, wherein assigning the hit record includes selecting the visit based on an Internet Protocol (IP) address within the hit record and a time delta since a previous hit record with the IP address.

6. A method according to claim 4, wherein assigning the hit record includes selecting the visit based on a cookie within the hit record and a time delta since a previous hit record with the cookie.

7. A method according to claim 1, wherein recognizing visit information includes identifying a content group viewed by the visitor.

8. A method according to claim 1, wherein recognizing visit information includes identifying an advertising campaign that brought the visitor to a business.

9. A method according to claim 1, the method further comprising extracting the visit information from a web-based form.

10. A method according to claim 9, wherein extracting the visit information includes identifying an amount of money spent during a visit.

11. A method according to claim 1, the method further comprising eliminating inaccurate counting of visit information from the database.

12. A method according to claim 11, wherein eliminating inaccurate counting includes:
identifying an open visit; and
deleting visit information derived from the open visit.

13. A method according to claim 12, wherein:
the method further comprises storing the hit record in a database; and
eliminating inaccurate counting further includes regenerating visit information from the hit record in the database for the open visit.

14. A method according to claim 12, wherein eliminating inaccurate counting further includes:
detecting an open visit in a current time slice;
determining a corresponding visit in an adjacent time slice; and
adding visit information from the open visit to the corresponding visit.

15. A method according to claim 1, wherein storing the visit information includes:
using a semaphore on the database for a time range; and
releasing the semaphore after the visit information is stored.

16. A method according to claim 15, wherein storing the visit information further includes blocking an operation on the time range until the semaphore is released.

17. A method according to claim 1, further comprising:
using a semaphore on the database;
retrieving the visit information from the database; and
releasing the semaphore after the visit information is retrieved.

18. A method according to claim 1, wherein storing the visit information further includes taking a snapshot of a setting for the database.

19. A method according to claim 1, wherein retrieving a hit record includes filtering the hit record.

20. A method according to claim 1, the method further comprising purging the visit information from the database.

21. A method according to claim 1, further comprising storing the hit record in the database.

22. A method according to claim 21, further comprising purging the hit record from the database.

23. A computer-readable medium containing a program to store network traffic data, the program comprising:
retrieval software to retrieve a hit record of network traffic data;
assignment software to assign the hit record to a visitor;
recognition software to recognize visit information for the visitor based on the hit record; and
storing software to store the visit information for the visitor in a database.

24. A computer-readable medium containing a program according to claim 23, wherein the retrieval software includes retrieval software to retrieve the hit record from a log file.

25. A computer-readable medium containing a program according to claim 23, wherein the retrieval software includes retrieval software to retrieve the hit record from the database.

26. A computer-readable medium containing a program according to claim 23, wherein the recognition software includes assignment software to assign the hit record to a visit.

27. A computer-readable medium containing a program according to claim 26, wherein the assignment software includes selection software to select the visit based on an Internet Protocol (IP) address within the hit record and a time delta since a previous hit record with the IP address.

28. A computer-readable medium containing a program according to claim 26, wherein the assignment software includes selection software to select the visit based on a cookie within the hit record and a time delta since a previous hit record with the cookie.

29. A computer-readable medium containing a program according to claim 23, wherein the recognition software includes identification software to identify a content group viewed by the visitor.

30. A computer-readable medium containing a program according to claim 23, wherein the recognition software includes identification software to identify an advertising campaign that brought the visitor to a business.

31. A computer-readable medium containing a program according to claim 23, the program further comprising extraction software to extract the visit information from a web-base form.

32. A computer-readable medium containing a program according to claim 31, wherein the extraction software includes identification software to identify an amount of money spent during a visit.

33. A computer-readable medium containing a program according to claim 23, the program further comprising elimination software to eliminate inaccurate counting of visit information from the database.

34. A computer-readable medium containing a program according to claim 31, wherein the elimination software includes:
identification software to identify an open visit; and
deletion software to delete visit information derived from the open visit.

35. A computer-readable medium containing a program according to claim 34, wherein:
the program further comprises storing software to store the hit record in a database; and
the elimination software further includes regenerating software to regenerate visit information from the hit record in the database for the open visit.

36. A computer-readable medium containing a program according to claim 34, wherein the elimination software further includes:
detection software to detect an open visit in a current time slice;
determination software to determine a corresponding visit in an adjacent time slice; and
addition software to add visit information from the open visit to the corresponding visit.

37. A computer-readable medium containing a program according to claim 23, wherein the storing software includes:
using software to use a semaphore on the database for a time range; and
releasing software to release the semaphore after the visit information is stored.

38. A computer-readable medium containing a program according to claim 37, wherein the storing software further includes blocking software to block an operation on the time range until the semaphore is released.

39. A computer-readable medium containing a program according to claim 23, the program further comprising:
using software to use a semaphore on the database;
retrieval software to retrieve the visit information from the database; and
releasing software to release the semaphore after the visit information is retrieved.

40. A computer-readable medium containing a program according to claim 23, wherein the storing software further includes snapshot software to take a snapshot of a setting for the database.

41. A computer-readable medium containing a program according to claim 23, wherein the retrieval software includes filtering software to filter the hit record.

42. A computer-readable medium containing a program according to claim 23, the program further comprising purging software to purse the visit information from the database.

43. A computer-readable medium containing a program according to claim 23, the program further comprising storing software to store the hit record in the database.

44. A computer-readable medium containing a program according to claim 43, the program further comprising purging software to purge the hit record from the database.

45. An apparatus designed to store network traffic data, the apparatus comprising:
a computer system;
at least one hit record on the computer system;
a database on the computer system, the database designed to store visit information derived from the hit record; and
means for deriving visit information from the hit record on the computer system.

46. An apparatus according to claim 45, wherein the hit record is stored in a log file on the computer system.

47. An apparatus according to claim 45, wherein the hit record is stored in the database on the computer system.

48. An apparatus according to claim 45, wherein the means for deriving includes a data extractor designed to extract the visit information from the hit record.

49. An apparatus according to claim 45, the apparatus further comprising means for eliminating inaccurately counted the visit information.

50. An apparatus according to claim 49, wherein the means for eliminating includes means for purging the inaccurately counted visit information from the database.

51. An apparatus according to claim 45, the apparatus further comprising a snapshot of a setting for the database.

52. An apparatus according to claim 45, the apparatus further comprising a semaphore for blocking an operation on a time range in the database.

53. A method for tracking a visit information, the method comprising:
assigning a name to the visit information;
specifying a source of a value for the visit information; and
storing the name of the visit information and the source of a value for the visit information in a database.

54. A method according to claim 53, wherein specifying a source includes identifying a uniform resource locator (URL) and a parameter name for the value for the visit information.

55. A method according to claim 53, the method further comprising:
accessing the value for the visit information for a visitor; and
linking the visit information, the visitor, and the value for the visit information in the database.

56. A computer-readable medium containing a program to track a visitor characteristic, the program comprising:
assignment software to assign a name to the visit information;
specification software to specify a source of a value for the visit information; and
storage software to store the name of the visit information and the source of a value for the visit information in a database.

57. A computer-readable medium containing a program according to claim 56, wherein the specification software includes identification software to identify a uniform resource locator (URL) and a parameter name for the value for the visit information.

58. A computer-readable medium containing a program according to claim 56, the program further comprising:
accessing software to access the value for the visit information for a visitor; and
linking software to link the visit information, the visitor, and the value for the visit information in the database.
